(19) United States
(12) Patent Application Publication
(10) Pub. No.: US 2012/0154966 A1
(43) Pub. Date: Jun. 21, 2012

(54) FAULT CURRENT LIMITERS (FCL) WITH THE CORES SATURATED BY NON-SUPERCONDUCTING COILS

(75) Inventors: Shuki Wolfus, Kiryat Ono (IL); Yossef Yeshurun, Ganei Tikva (IL); Alexander Friedman, Lod (IL); Vladimir Rozenshtein, Ihud (IL); Zvi Bar-Haim, Ihud (IL)

(73) Assignees: RICOR CRYOGENIC & VACUUM SYSTEMS LIMITED PARTNERSHIP, Ihud (IL); BAR ILAN RESEARCH & DEVELOPMENT COMPANY LTD., Ramat Gan (IL)

(21) Appl. No.: 13/393,287

(22) PCT Filed: Aug. 31, 2010
(86) PCT No.: PCT/IL10/00715

§ 371 Date: Feb. 29, 2012

Related U.S. Application Data
(60) Provisional application No. 61/272,200, filed on Aug. 31, 2009.

(51) Int. Cl. H02H 9/00; H01F 29/14

(52) U.S. Cl. 361/58; 29/602.1

(57) ABSTRACT

A current limiting device (30, 40, 50, 60) comprising for each phase of an AC supply a closed magnetic core (31) of reduced volume and mass having first and second pairs of opposing limbs (32a, 32b; 33a, 33b), and at least one AC coil (35a, 35b) enclosing opposing limbs (33a, 33b) of the magnetic core (31) and adapted for series connection with a load. A non-superconducting DC bias coil (34) typically formed of copper encloses a limb (32a, 32b) of the magnetic core (31) for saturating each of the opposing limbs (33a, 33b) in opposite directions by the bias coil (34). Under fault conditions, the AC flux in at least one limb counteracts the DC bias flux, bringing the limb out of saturation. Preferably, current is reduced in the DC bias coils thus bringing both opposing limbs of the core out of saturation.

### RELATED APPLICATION

This application is a c-i-p application of U.S. Ser. No. 12/066,228 filed Sep. 7, 2005 entitled “Fault current limiters (FCL) with the cores saturated by superconducting coils” and corresponding to WO 2007/029224.

### FIELD OF THE INVENTION

This invention relates to current limiting devices for AC electric grid.

### REFERENCES

In the following description, reference will be made to the following publications:
[1] B. P. Raju, K. C. Parton, T. C. Bartram, “A current limiting device using super-conducting d.c. bias: applications and prospects,” IEEE Transactions on Power Apparatus & Systems, vol. 101, pp. 3173-3177, 1982.
[2] J. X. Jin, S. X. Dou., C. Grantham, and D. Sutanto “Operating principle of a high T-c superconducting saturable magnetic core fault current limiter”. Physica C, 282, Part 4: p. 2643-2644, 1997.
[3] J. X. Jin, S. X. Dou., C. Cook, C. Grantham, M. Apperley, and T. Beals, “Magnetic saturable reactor type HTS fault current limiter for electrical application”. Physica C, 2000. 341-348: p. 2629-2630.
[4] V. Keilin, I. Kovalev, S. Kruglov, V. Stepanov, I. Shugaev, V. Shcherbakov, I. Akimov, D. Rakov, and A. Shikov, “Model of HTS three-phase saturated core fault current limiter”, IEEE Transactions on Applied Superconductivity, vol. 10, pp. 836-839, 2000.
[5] R. F. Giese, “Fault-current limiters—A second look,” Argonne Nat. Lab., Argonne, USA Mar. 16, 1995.
[6] WO 2004/068670 (Yosef Yeshurun et al.) published Dec. 8, 2004 “Fault current limiters (FCL) with the cores saturated by superconducting coils.”
[7] WO 2007/029224 (Yosef Yeshurun et al.) published Mar. 15, 2007 “Fault current limiters (FCL) with the cores saturated by superconducting coils.”

### BACKGROUND OF THE INVENTION

Saturated-core based Fault Current Limiters (FCL) with variable impedance are expected to be the most cost effective solution for short circuit current limiting. Saturated cores FCLs offer quick response and fast recovery, relatively low energy dissipation, tolerance to large fault currents and the possibility for virtually unlimited number of operations.

More particularly, the present invention relates to current limiting devices based on a copper coil with saturated core. A review of the prior art relating to FCLs with saturated cores is given in our earlier WO 2004/068670 and WO 2007/029224 and is not repeated here.

In WO 2007/029224 we observed that known designs of FCL with saturated cores have essential shortcomings that prevent development and realization of this type of FCL. Its weakest points are the large weight and dimensions [5]. Also, FCL designs using closed DC-Closed AC magnetic circuit exhibit inherent “transformer-like” magnetic coupling between the DC and AC coils when the core is not deeply saturated. As a result, the bias coils have to maintain high saturation levels under the DC coil at all times, in particular during fault state, where the coupling level is maximal. This is achieved by applying high ampere-turn to the DC bias thus contributing to the need to use superconducting coils as an only option.

In known designs, a cryostat with bias coils is placed in the window of the core thus increasing its size. The size of the magnetic core is defined mostly by its cross-section, which in turn is determined by the required voltage drop on the FCL during a fault. This voltage is proportional to the product of the cross-section of the core with the number of turns in the AC coil. The number of turns is limited by the allowable voltage drop on the FCL at normal operation.

In WO 2007/029224 we describe an FCL comprising for each phase of an AC supply a closed magnetic core of reduced volume and mass having first and second pairs of opposing limbs, and at least one AC coil enclosing opposing limbs of the magnetic core and adapted for series connection with a load thus producing an open AC magnetic circuit. A superconducting DC bias coil encloses a limb of the magnetic core for saturating each of the opposing limbs in opposite directions by the bias coil. Under fault conditions, the AC flux in one limb counteracts the DC bias flux, bringing the limb out of saturation.

It thus transpires that while the large size of the FCL due to the overhead imposed by the cryostats required for the superconducting DC bias coils is addressed by the arrangement taught in WO 2007/029224, no attempt was made to avoid the need for superconducting DC bias coils. Given the long history of FCLs and the almost predominant use of superconducting DC bias coils this is not surprising.

Thus fault current limiters employing a closed magnetic circuit and superconducting DC bias coils are well known in the art and are described, for example, in U.S. Pat. Nos. 3,219,918 and 4,045,823. A similar device is disclosed by Raju B. P. et al. [1] where at pages 3174-5 the physical characteristics of their superconducting coil are described, it being noted on page 3175 that the coil has 401 turns, and that the sampled DC current is 1150 A at 3.5 T. This translates to 461,150, ampère-turns, which is very difficult to realize in a non-superconducting coil, such as copper, within the volume defined by the core window size and for the described FCL application would mean very high Ohmic losses and very large coils.

This is also borne out from U.S. Pat. No. 4,045,823 to Parton, who is a co-author of the above-mentioned article [1] which, also employs a closed DC magnetic circuit, and yet still employs a superconducting DC bias coil. In other words, more than fifteen years after publication of the above-mentioned article, one of the same authors still found it natural to employ a superconducting DC bias coil in a current limiting device employing a closed DC magnetic circuit.

In summary, it emerges that FCLs employing closed DC magnetic circuits and superconducting DC bias coils is well-established. The use of superconducting DC bias coils when using closed DC magnetic circuits is natural for a number of reasons. First, in previous core designs employing both a closed DC bias circuit and a closed AC circuit, the total DC magnetic length requires high ampere-turn levels, for which non-superconducting coils present no competition economically or performance wise to superconducting coils. This is because the cost and space overhead imposed by the cryostat is less than the cost of copper wire in a non-superconducting coil and the consequently vast structure thus created.

WO 2007/029224 employs an open AC magnetic circuit and a closed DC bias circuit in order to reduce the mass of the magnetic circuit. However, here also super-conducting DC bias coils are employed. There is no suggestion in the art to employ a closed DC bias circuit with an open AC magnetic circuit and to use non-superconducting DC bias coils, such as copper. Indeed, based on what we have explained above, it is counter-intuitive to do so because the motivation to use an open AC magnetic circuit is precisely to reduce the mass of the AC magnetic circuit, while the very high number of ampère-turns required in the DC bias coil, militates against the use of a non-superconducting coil, such as copper, and would result in very high Ohmic losses and very large coils.

It would therefore be desirable to provide an improved design of FCL having a non-superconducting copper bias coil such as copper wherein this drawback is addressed without compromising the advantages afforded by the configurations proposed in WO 2004/068670 and WO 2007/029224.

### SUMMARY OF THE INVENTION

It is an object of the present invention to provide an FCL with saturated core that includes at least one copper DC bias coil placed on a single closed ferromagnetic core, which serves as open core for a single AC coil and yet which, surprisingly, does not require a superconducting DC bias coil.

A further object of the invention is to provide an improved current limiter with saturated core where the bias field is decreased or eliminated at the time of a fault by disconnecting the bias coils from their power supply and connecting them in a voltage limiting circuit with energy absorbing elements controlling maximal voltage on the coils. The disconnection is realized by a switching device, controlled by the voltage drop on the AC coil, that also restores the DC coil circuit after disconnecting the fault.

Yet another object of the invention is to provide switching of the DC circuit that connects two bias coil segments in opposite directions relative to an initial connection for preventing a possible transformer coupling effect at the time of fault.

Additional objectives of the present invention are:
to reduce the alternating magnetic field on the DC bias coils thus preventing a degradation of their critical current;
to reduce the number of Ampère-turns of the bias coils without increasing the core size.

These objects are realized in accordance with a first aspect of the invention by a current limiting device for an AC supply, said current limiting device comprising for each phase of the AC supply:

a magnetic circuit forming an open magnetic core for at least one AC coil and forming a closed magnetic circuit for at least one non-superconducting DC bias coil that is adapted under non-fault conditions to bias the magnetic core into saturation so that each of the opposing limbs is saturated in opposite directions by the bias coil.

Such design of a current limiter allows building the FCL with saturated core having a small mass and dimensions and also reduces or eliminates the transformer coupling between the AC coil and the DC bias coil(s).

The magnetic circuit preferably comprises:

a closed magnetic core having a first pair of opposing limbs and a second pair of opposing limbs,

at least one AC coil enclosing opposing limbs of the magnetic core and being adapted to be connected in series with a load, and

at least one non-superconducting DC bias coil enclosing at least one limb of the magnetic core and being adapted under non-fault conditions to bias the magnetic core into saturation so that each of the opposing limbs is saturated in opposite directions by the bias coil.

Since the AC coil is commonly wound externally on both limbs of the core, the AC coil sees an open core, opposing limbs of which are subjected to AC flux in the same direction, which will alternate during alternate half-cycles of the AC current. As against this, the DC bias coil is wound internally on the core in a way that forms a closed magnetic circuit for the DC flux and affects the magnetic permeability of the complete core. Specifically, the DC bias coil ensures that the core is magnetized whereby under non-fault conditions its magnetic permeability is low. Moreover, since the flux produced by the DC bias coil encircles the four limbs of the magnetic core in a fixed angular direction (clockwise or anti-clockwise) determined by the direction of the DC current, it always acts in the same direction as the AC flux in one limb and in the opposite direction of the AC flux in the opposite limb. The dimensions of the magnetic core and the number of turns of the AC coil are so designed that, even under maximum fault conditions, the current in the AC coil does not bring the core into saturation. Therefore, even under maximum fault conditions, the AC flux adds to the saturation produced by the DC bias coil in one limb; while in the opposite limb, the AC flux acts to bring the limb out of saturation produced by the DC bias coil. The limb that remains in saturation exhibits low magnetic permeability, while the limb that is no longer saturated exhibits high magnetic permeability. What this means is that, in effect, under fault conditions some of the cross-sectional area of the magnetic core always contributes to high coil impedance and serves, thereby, to limit the fault current.

Such an arrangement, whereby the AC coil is wound on an open magnetic core, while the DC bias coil is adapted under non-fault conditions to bias opposing limbs of the magnetic core into saturation in opposite directions, has not been proposed previously and allows the effective cross-sectional area of the magnetic core and/or the Ampère-turns in the DC bias coil to be reduced.

In order to improve the efficiency of the device and bring the whole of the magnetic core out of saturation under fault conditions, the DC electric circuit of bias coils is preferably supplied with a current reduction unit that reduces the DC bias current during fault conditions. Better effectiveness is achieved where the current reduction unit is constituted by a switching unit that disconnects the bias coils from the DC power supply at the time of fault and includes the bias coils and energy absorbing elements that also limit the voltage on bias coils.

The switching enables the maximal voltage drop on the current limiter to be increased as compared with an FCL without switching because both legs of the core are out of saturation and the effective cross-section of the core is increased. An additional effect of using the switching unit (as a result of increasing the effective core permeability) is a strong reduction of the leakage AC. When the DC bias coils are energized, the DC flux always provides a positive offset to the AC flux in one of the limbs and a negative offset to the AC flux in the opposite limb. When the DC switches off, the magnetic picture becomes symmetric and all limbs of the magnetic core are unsaturated, thereby contribute to high magnetic impedance.

The switching unit allows the mass of the device to be reduced regardless of the type of core employed in the same way as described above in relation to the feedback coil.

In accordance with another aspect of the invention, there is provided a method for reducing mass of a current limiting device for an AC supply, said current limiting device comprising for each phase of the AC supply a magnetic circuit that offers low impedance under non-fault conditions and high impedance under fault conditions, said method comprising:

constructing the a magnetic circuit so as to form an open magnetic core for at least one AC coil and forming a closed DC magnetic circuit for at least one non-superconducting bias coil that is adapted under non-fault conditions to bias the magnetic core into saturation so that each of the opposing limbs is saturated in, opposite directions by the bias coil;

whereby under fault conditions some of the cross-sectional area of the magnetic core always exhibits high permeability and serves, thereby, to resist the fault and allow the cross-sectional area of the at least one AC coil and magnetic core to be reduced.

Preferably, said method further comprises:

reducing current in the at least one non-superconducting DC bias coil during a fault condition thereby bringing the core out of saturation.

### BRIEF DESCRIPTION OF THE DRAWINGS

In order to understand the invention and to see how it may be carried out in practice, some preferred embodiments will now be described, by way of non-limiting examples only, with reference to the accompanying drawings, in which:

FIG. 1 shows pictorially a prior art closed core configuration of a saturated core single phase FCL;

FIG. 2 is a schematic circuit diagram showing the prior art single phase FCL of FIG. 1 in use;

FIG. 3 shows a magnetic circuit having a closed core for a single phase FCL according to first embodiment of the invention;

FIG. 4 shows the form of a core for a single phase FCL according to a second embodiment of the invention;

FIG. 5 shows a saturated core FCL according to a third embodiment of the invention;

FIGS. 6a and 6b show a saturated core FCL according to a fourth embodiment of the invention;

FIG. 7 is a schematic circuit diagram showing a single phase FCL according to an embodiment of the invention with a switching system for disconnecting power from the bias coils during a fault condition; and

FIG. 8 is a schematic circuit diagram showing a single phase FCL according to an embodiment of the invention with a switching system for disconnecting power from the bias coils and reconnecting them in mutually opposed relationship during a fault condition.

### DETAILED DESCRIPTION OF EMBODIMENTS

In the following description various embodiments are described. To the extent that many features are common to different embodiments, identical reference numerals will be employed to refer to components that are common to more than one figure.

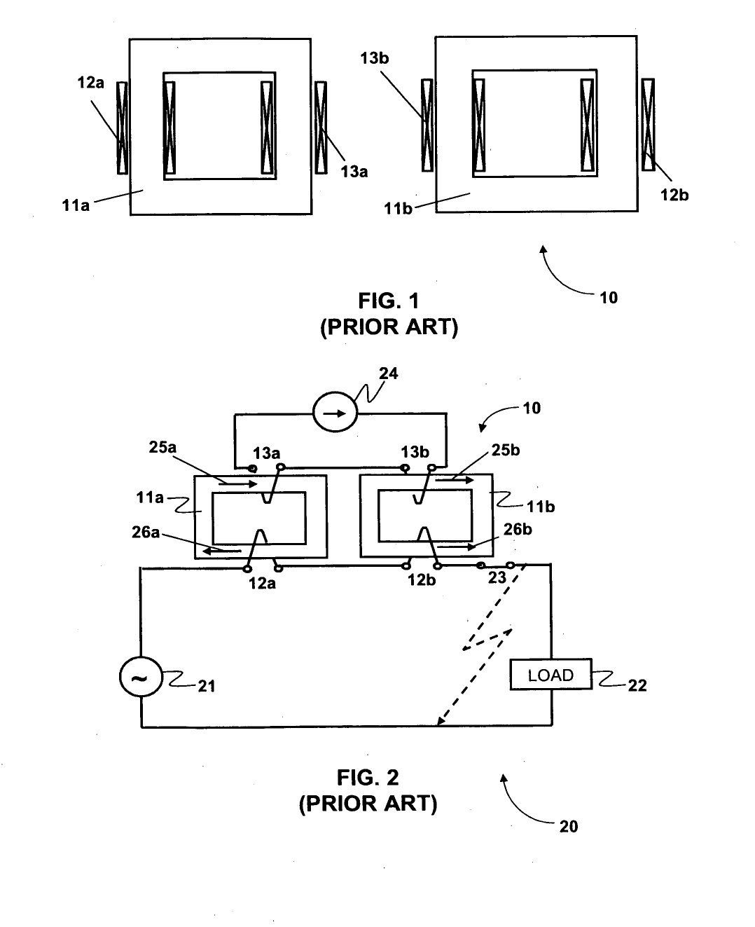

In order more fully to appreciate the benefits of the invention, it will be instructive first to consider a typical prior art single phase FCL. To this end, FIG. 1 shows pictorially a prior art saturated core single phase FCL 10 having a magnetic circuit comprising a pair of closed magnetic cores 11a and 11b each supporting a respective AC coil 12a and 12b. The cores further support a pair of DC superconducting bias coils 13a and 13b.

FIG. 2 shows schematically a circuit diagram of a system 20 showing the single phase FCL 10 in use. An AC supply 21, typically from the electric power grid, is connected to a load 22 via a circuit breaker 23. In series with the load 22 are connected the two AC coils 12a and 12b of the FCL 10. The respective superconducting bias coils 13a and 13b are connected to a DC power supply 24. At any moment the direction of the bias magnetic flux 25a in one core coincides with the direction of the magnetic flux 26a of the AC coil 12a whereas the direction of the bias magnetic flux 25b in the other core is opposite to the direction of the magnetic flux 26b of the AC coil 12b. Under normal conditions, the bias coils 25a and 25b saturate the respective cores 11a and 11b. Under fault conditions, the AC coils 12a and 12b draw the respective cores 11a and 11b out of saturation during opposite half cycles of the AC cycle, thereby causing their average inductance to increase, thus limiting the current increase.

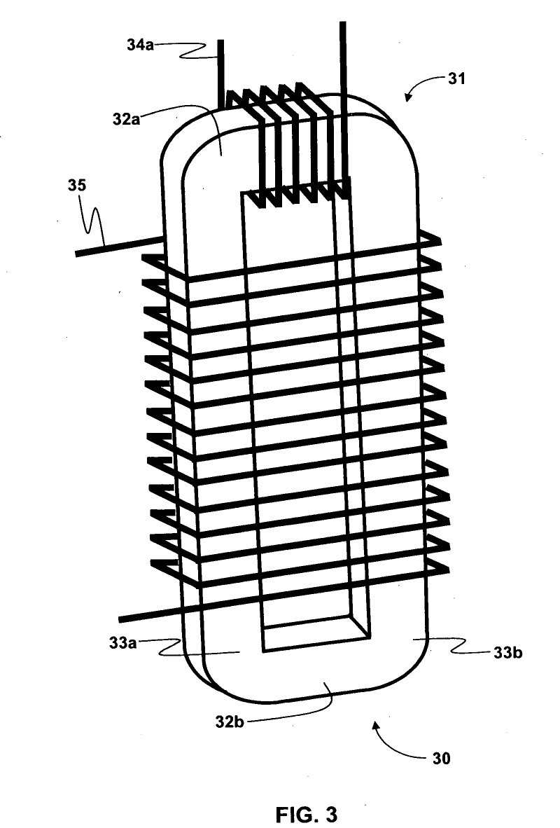

Reference [1] describes a realization of an FCL of the kind shown in FIG. 2 using closed DC-closed AC magnetic circuits. A magnetic field of about 1000 Oe (i.e. 80000 A/m) was used to saturate the core and achieve the required normal state impedance. Namely, about 400,000 ampere-turns were used to saturate a core window of approximately 4 m magnetic length. The magnetic length and the ampere-turns double in the full double window core of FIG. 3 and are approximately 8 m in length and 800,000 ampere-turns respectively. In an attempt to realize such an FCL using a copper coil, one would have need to use approximately 8000 turns of copper wire carrying 100 A in a cross-section of about 50 mm². Such coil would have required length of wire of 16 km that exhibits a resistance of about 5.8 Ohm. The continuous ohmic losses associated with such current and resistance are therefore about 58 kW, which are much higher than the typical 5-20 kW cryo-cooler power that would have been required for superconducting coils that supply the same ampere-turns. It may thus be concluded that the magnetic length and the magnetic field required for such an FCL configuration exclude copper coils as an option for use as bias coils.

FIG. 3 shows a single phase FCL 30 according to a first embodiment of the invention having a magnetic circuit comprising a single closed core 31 having opposing pairs of short legs 32a and 32b and long legs 33a and 33b as compared with the two closed cores of known designs as shown in FIG. 2. A single non-superconducting bias coil 34 is placed on one of the short legs 32a of the closed core 31. In this embodiment only one AC coil 35 is used that encircles the two long legs 33a and 33b of the core in such a way that the AC coil is disposed on the open magnetic core. An advantage of such an arrangement of transverse AC and DC bias coils is that transformer coupling of the coils is decreased, since the mutual inductance between the coils is ideally zero when the DC is off and the AC fluxes in opposing limbs are equal and cancel each other at the centers of transverse limbs.

The configuration shown in FIG. 3 turns out to be economically viable because a much reduced magnetic field of 300 Oe is sufficient to saturate the closed DC-open AC than the 1000 Oe required for the closed DC-closed AC configuration shown in FIG. 2. Furthermore, the magnetic length of the DC circuit in FIG. 3 given by the perimeter of the closed single core is reduced by a factor of 2-3 in comparison to the closed DC-closed AC configuration of FIG. 2. This leads to a total reduction in the ampere-turns by a factor of 6-10, which renders the cost of a copper bias coil economically viable compared with the cost of maintaining a superconducting coil.

It is reiterated that a structure similar to that shown in FIG. 3 is described in WO 2007/029224 but employs superconducting bias coils. However, while super-conducting coils provide higher current density than non-superconducting coils and therefore may saturate the core offering a more compact solution than non-superconducting coils with less ohmic losses, the reduced DC magnetic length offered by the design of FIG. 3 allows the option to achieve saturation by non-superconducting coils as well. In many cases this will turn out to be a more desirable, cost-effective solution as it saves the cost and complexity of using cryogenic technology in close vicinity to high-voltage devices.

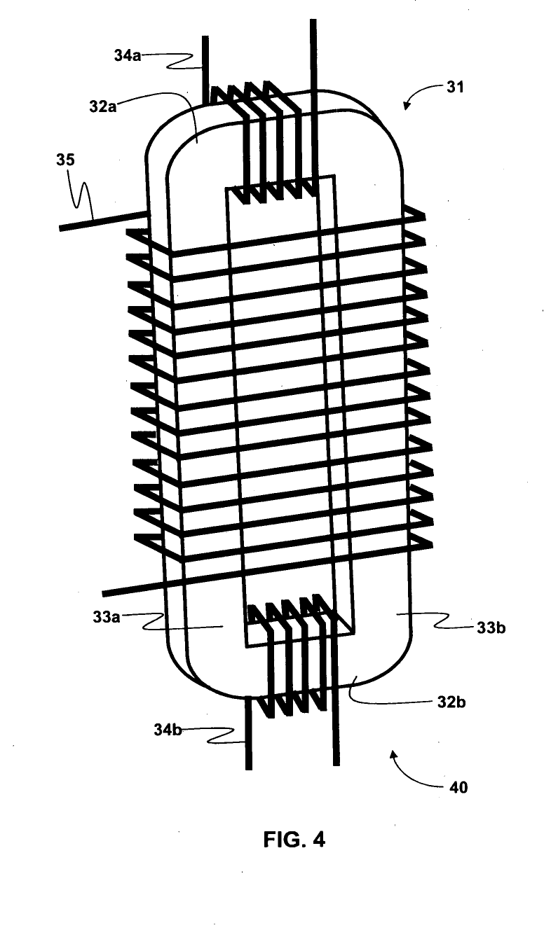

FIG. 4 shows an FCL 40 according to a second embodiment similar to the first embodiment in which, instead of the single bias coil 34, two bias coils 34a and 34b are placed on the opposite short legs 32a and 32b of the core thus enabling better saturation of the core with the same total number of Ampère-turns in the bias coils. This is achieved by splitting the original. DC bias coil shown in FIG. 3 to two copper coils while maintaining the Ampère-turns. This is done because areas in the core, which are remote from the coil, are less saturated than areas close to the coil.

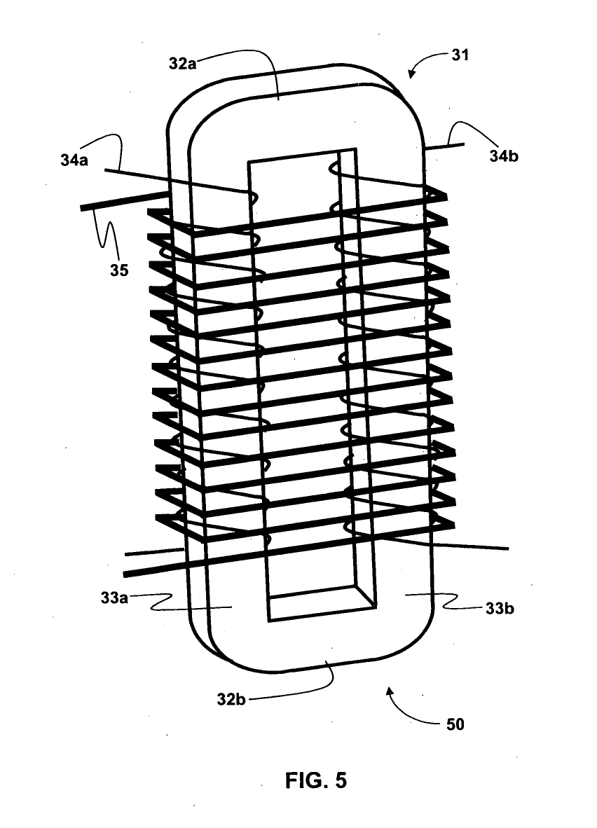

FIG. 5 shows an FCL 50 according to another exemplary embodiment having an identical closed core 31 and a common AC coil 35 wound around the long legs 33a and 33b of the core. Two DC bias coils 34a and 34b are placed on the two long legs 33a and 33b of the core encompassed by the AC coil 35 thus enabling better saturation of the core with a smaller number of Ampère-turns of the bias coils.

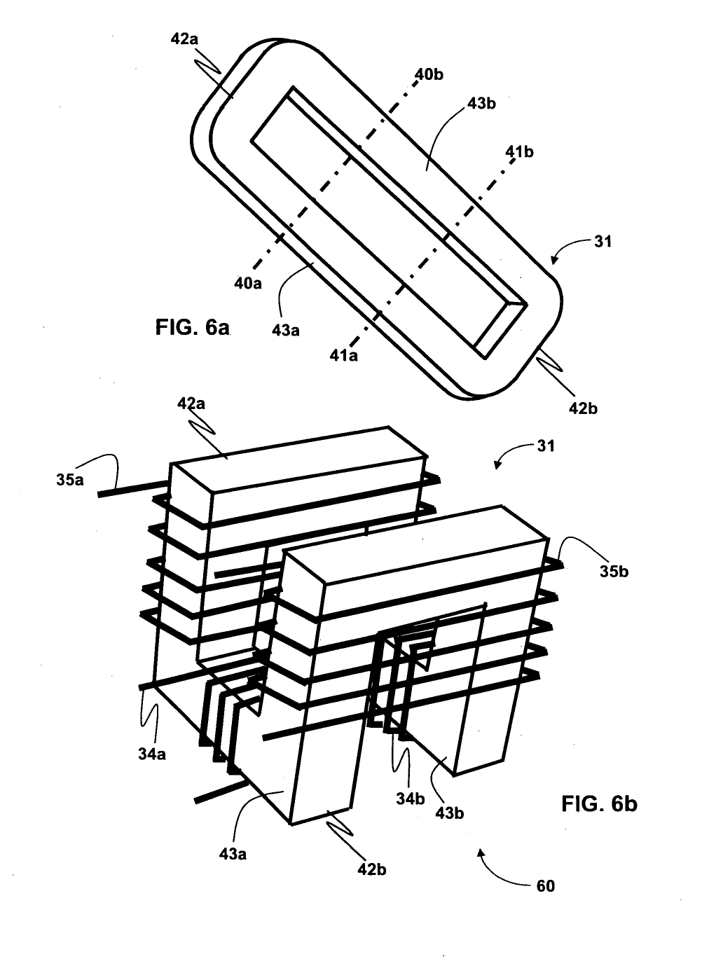

FIGS. 6a and 6b show an FCL 60 according to another exemplary embodiment having a closed magnetic core 31 that is formed by folding the core 31 shown in FIG. 6a and corresponding to that shown in FIG. 2, 3 or 4 about a pair of lines 40a-40b and 41a-41b so as to form a pair of spaced apart C-shaped cores 42a, 42b as shown in FIG. 6b. The C-shaped cores 42a, 42b face each other and the open ends of respective limbs of each core are magnetically coupled by legs 43a and 43b so as to form a closed magnetic circuit. Two bias coils 34a and 34b are wound on the legs 43a and 43b of the core. A first AC coil 35a encloses the opposite limbs of the C-shaped core 42a and a second AC coil 35b encloses the opposite limbs of the C-shaped core 42b. Such a configuration enables better saturation of the core than in the first embodiment shown in FIG. 3.

All the above-described embodiments are characterized by an AC coil 35 that encloses two limbs of the core magnetized to saturation in opposite directions by the DC coils. The core is never saturated by the AC coil alone but only by the DC bias coils which magnetize the “AC limbs” in opposite directions during opposite half cycles of the AC supply. As a result during a fault condition only one limb is driven out of saturation while the other limb is further drawn into deeper saturation if the DC bias coils continue to magnetize the core as is typically done in hitherto-proposed FCLs. However, if at the moment of fault, the current in the DC bias coil or coils 34 is reduced as is done in the invention, the maximal magnetic flux of the AC coil can be increased without saturating the core, thus increasing the maximal allowable voltage drop on the FCL. This effect is equivalent to decreasing the size of the core because during a fault both limbs are driven out of saturation. As a result, the cross-sections of the AC coil and the core can be reduced.

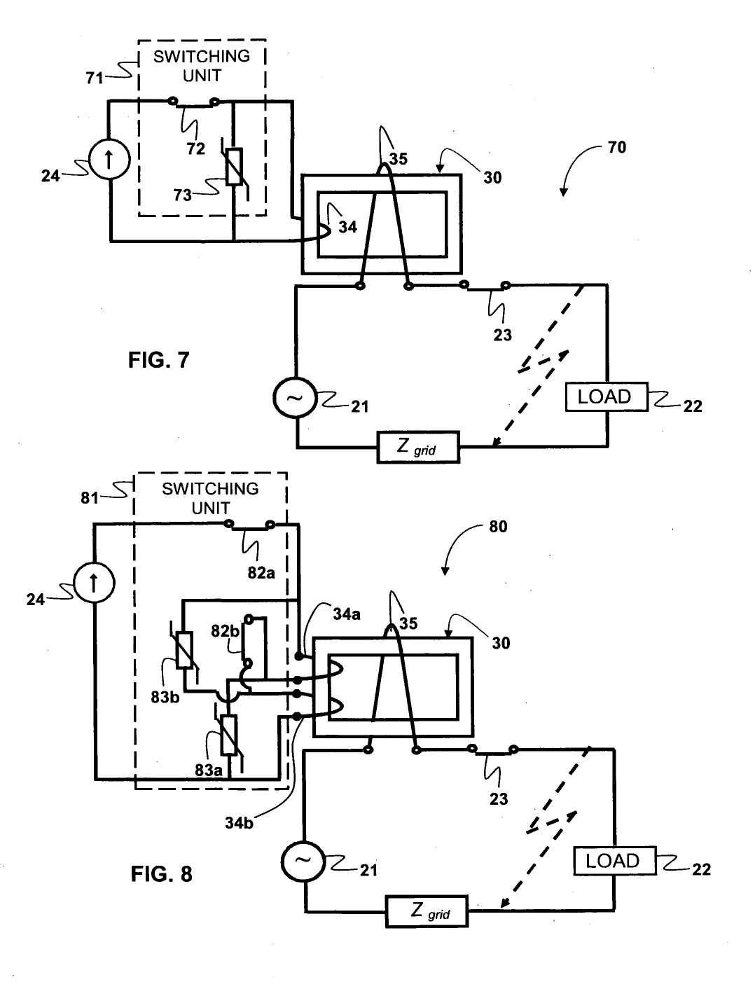

FIG. 7 is an exemplary schematic circuit diagram showing a system 70 that includes the FCL 30 shown in FIG. 3, wherein the bias coil 34 is energized by a DC supply 24 via a switching unit 71 that includes fast transistor switch 72 and an energy absorbing element 73 limiting maximal voltage in the electric circuit. The switching unit 71 thus serves to reduce current in the DC bias coil. Other elements are similar to the system 20 shown in FIG. 2 and have the same labeling. The system 70 operates as follows. At any moment the magnetic flux in both limbs will be directed to the left or to the right in the figure, since the AC coil 35 is commonly wound on both limbs. Under normal conditions, the DC bias coil 34 saturates the core so that limbs 33a and 33b are saturated in opposite directions, and the AC coil 35 thus exhibits low impedance. Under fault conditions, the current through the AC coil increases and, for so long as the DC bias coil 34 remains effective, during alternate half cycles, the AC coil 35 de-saturates a respective one of the limbs 33a and 33b. Therefore, the magnetic flux inside the AC coil 35 and its related inductance is defined by only one of the limbs 33a and 33b, i.e. by half of the full core cross-section. However, if under fault conditions the switching unit 71 disconnects the DC power source 24 from the DC bias coil 34, its current falls down, thereby de-saturating the complete core including limbs 33a and 33b, and doubling the effective cross-section of the core inside the AC coil 35 and increasing its impedance. This means that an equivalent current limiting effect can be achieved with such a topology having significantly reduced cross-sectional area of the AC coils and magnetic core compared with hitherto-proposed topologies.

The energy-absorbing element 72 is necessary to limit the voltage across the coil 34 during the time of switching. During this transient time regime the magnetic fluxes in limbs 33a and 33b are not equal and a fast change of the magnetic flux in limbs 32a and 32b may induce an alternating voltage/current on the bias coil(s) that might be harmful for the DC bias coils. The switching unit 71 not only disconnects the DC power source 24 from the DC bias coil 34 but also connects the two DC bias coils 34a, 34b or two segments of one DC bias coil 34 in opposite directions thus minimizing the overall AC voltage in the DC bias coils circuit and preventing AC current from flowing therein. Two energy-absorbing elements 83a, 83b are necessary for limiting the voltage on each DC bias coil or half coil. The voltage drop on the FCL triggers the switching circuit 71. When a fault occurs, this voltage changes abruptly by typically one order of magnitude allowing accurate and reliable fault detection.

FIG. 8 is an exemplary schematic circuit diagram showing a system 80 that includes the FCL 40 or 50 shown in FIGS. 4 and 5, respectively, having two DC coils 34a and 34b that are energized by a DC supply 24 via a switching unit 81. The switching unit 81 includes first and second fast transistor switches having normally closed contacts 82a, 82b and normally open contacts 82c, 82d and corresponding first and second energy absorbing elements 83a, 83b that limit maximal voltage in the electric circuit. Under fault conditions, the contacts 82a and 82b open thereby disconnecting the DC supply 24 from the DC bias coils 34a and 34b; while, at the same time, the contacts 82c and 82d close thereby connecting respective DC bias coils 34a and 34b in anti-phase so that the DC bias coils 34a and 34b are counter wound relative to each other in a way that the possible induced voltage on both DC coils and current therein are minimized. The energy absorbing elements 83a, 83b limit the voltage on each of the bias coils.

It will be understood that modifications are possible to the exemplary embodiments as described without departing from the scope of the invention as claimed. Thus, in the exemplary embodiments, a switching unit is used to disconnect the DC supply from the DC bias coils and thereby reduce the DC bias current to zero. Under these conditions, the AC fluxes in the opposing limbs of the magnetic core equal each other. However, the invention also contemplates reducing the DC bias current to less than zero. This will still work as at least half of the core's cross-section always is driven out of saturation by the AC coil current. Any reduction in the DC bias current adds to the effective cross-section participating in the limiting effect. Current reduction may be achieved using feedback, for example, as taught in WO 2007/029224 and WO 2004/068670 or using any other suitable method.

It will also be appreciated that the invention embraces any magnetic circuit forming an open magnetic core for at least one AC coil and forming a closed magnetic circuit for at least one copper bias coil that is adapted under non-fault conditions to bias the magnetic core into saturation so that each of the opposing limbs is saturated in opposite directions by the bias coil. Such a magnetic circuit has utility for a current limiting device independent of the switching unit, even though without reducing the DC bias current the efficiency would be lower. The term current reduction unit as used in the description and appended claims embraces any circuit for reducing DC bias current, whether the DC bias current remains non-zero or is disconnected altogether.

Finally, it will be appreciated that while in the described embodiments, the non-superconducting are formed of copper, the invention is not to be construed as being limited thereto, and any other suitable metal such as aluminum, silver, gold, metal alloys, etc. may be employed.

1. A current limiting device (30, 40, 50, 60) for an AC supply, said current limiting device comprising for each phase of the AC supply:
a magnetic circuit forming an open magnetic core (31) for at least one AC coil (35a, 35b) enclosing opposing limbs (33a, 33b) of the magnetic core (31) and forming a closed magnetic circuit for at least one non-superconducting DC bias coil (34a, 34b) that is adapted under non-fault conditions to bias the magnetic core into saturation so that each of the opposing limbs (33a, 33b) is saturated in opposite directions by the bias coil (34a, 34b).

2. The current limiting device (30) according to claim 1, wherein the open magnetic core (31) is dimensioned so that ampere-turn-related power losses are comparable to or lower than the power that would be required to cool a superconducting coil sufficiently if a superconducting DC bias coil were used instead.

3. The current limiting device (30) according to claim 1, wherein the magnetic circuit includes:
a closed magnetic core (31) having a first pair of opposing limbs (32a, 32b) and a second pair of opposing limbs (33a, 33b),
at least one AC coil (35a, 35b) enclosing opposing limbs (33a, 33b) of the magnetic core (31) and being adapted to be connected in series with a load, and
at least one non-superconducting DC bias coil (34a, 34b) enclosing at least one limb (32a, 32b) of the magnetic core (31) and being adapted under non-fault conditions to bias the magnetic core into saturation so that each of the opposing limbs (33a, 33b) is saturated in opposite directions by the bias coil (34a, 34b).

4. The current limiting device (30) according to claim 3, including:
a single non-superconducting DC bias coil (34a, 34b) one limb (32a) of the first pair of opposing limbs (32a, 32b), and
a single AC coil (35) enclosing the second pair of opposing limbs (33a, 33b).

5. The current limiting device (40) according to claim 3, including:
a pair of non-superconducting DC bias coils (34a, 34b) each enclosing a respective limb of the first pair of opposing limbs (32a, 32b), and
a single AC coil (35) enclosing the second pair of opposing limbs (33a, 33b).

6. The current limiting device (50) according to claim 3, including:
a pair of non-superconducting DC bias coils (34a, 34b) each enclosing a respective limb of the second pair of opposing limbs (33a, 33b), and
a single AC coil (35) enclosing the second pair of opposing limbs (33a, 33b).

7. The current limiting device (60) according to claim 3, wherein the magnetic core includes:
first and second spaced apart C-shaped cores (42a, 42b) each having limbs whose respective open ends are magnetically coupled by respective legs (43a, 43b),
a pair of DC bias coils (34a, 34b) each enclosing a respective one of the legs (43a, 43b) of the core,
a first AC coil (35a) enclosing opposite limbs of the first C-shaped core (42a), and
a second AC coil (35b) enclosing opposite limbs of the second C-shaped core (42b).

8. The current limiting device according to claim 1, further including a current reduction unit (71) for reducing current in the at least one non-superconducting DC bias coil (34a, 34b) during a fault condition.

9. The current limiting device according to claim 8, wherein the current reduction unit (71) is adapted to disconnect the at least one non-superconducting DC bias coil (34a, 34b) from the power supply during a fault condition.

10. The current limiting device according to claim 8, wherein a respective energy absorbing element (73, 83a, 83b) is connected across the at least one DC bias coil (34a,34b).

11. The current limiting device according to claim 8, wherein the current reduction unit (71) is controlled by the voltage drop on the at least one AC coil (35a, 35b) so as to reduce current in the bias coils during a fault condition and restore current in the bias coils after the disconnection or termination of the fault.

12. The current limiting device according to claim 1, wherein each of the DC bias coils (34a, 34b) is formed of copper.

13. A method for reducing mass of a current limiting device for an AC supply, said current limiting device comprising for each phase of the AC supply a magnetic circuit that offers low impedance under non-fault conditions and high impedance under fault conditions, said method comprising:
constructing the magnetic circuit so as to form an open magnetic core for at least one AC coil and forming a closed magnetic circuit for at least one non-superconducting DC bias coil that is adapted under non-fault conditions to bias the magnetic core into saturation so that each of the opposing limbs is saturated in opposite directions by the bias coil;
whereby under fault conditions some of the cross-sectional area of the magnetic core always exhibits high permeability and serves, thereby, to resist the fault and allow the cross-sectional area of the at least one AC coil and magnetic core to be reduced.

14. The method according to claim 13, further comprising:
reducing current in the at least one non-superconducting DC bias coil (34a, 34b) during a fault condition thereby bringing the at least one AC coil (35a, 35b) out of saturation and allowing a cross-sectional area of the AC coils and magnetic core to be reduced.

15. The method according to claim 13, including:
disconnecting the at least one non-superconducting DC bias coil (34a, 34b) from the power supply during a fault condition.

16. The method according to claim 12, wherein the magnetic circuit includes a pair of non-superconducting DC bias coils (34a, 34b) and there is further included:
connecting the non-superconducting DC bias coils (34a, 34b) in anti-phase so as to minimize possible induced voltage across and current through the nonsuperconducting DC bias coils.

17. The method according to claim 13, further including connecting the at least one DC non-superconducting bias coil (34a, 34b) to a respective energy absorbing element (73, 83a, 83b).
